(19) United States
(12) Patent Application Publication
(10) Pub. No.: US 2013/0250055 A1
(43) Pub. Date: Sep. 26, 2013

(54) METHOD OF CONTROLLING A 3D VIDEO CODING RATE AND APPARATUS USING THE SAME

(71) Applicant: ELECTRONICS AND TELECOMMUNICATIONS RESEARCH IN, Daejeon (KR)

(72) Inventors: Suk Hee CHO, Daejeon (KR); Se Yoon JEONG, Daejeon (KR); Jong Ho KIM, Daejeon (KR); Jin Soo CHOI, Daejeon (KR); Jin Woong KIM, Daejeon (KR)

(73) Assignee: Electronics and Telecommunications Research Institute, Daejeon (KR)

(21) Appl. No.: 13/651,294

(22) Filed: Oct. 12, 2012

(30) Foreign Application Priority Data
Mar. 22, 2012 (KR) 10-2012-0029534

(51) Int. Cl. H04N 7/26; H04N 13/00

(52) U.S. Cl. 348/43; 348/E13.062

(57) ABSTRACT

A 3D video encoding rate controlling method and an apparatus using the method are disclosed. An image encoding method includes encoding first and second images at a first encoding ratio, with an encoding rate of the first image different from an encoding rate of the second image and after encoding the first and second images at the first encoding ratio, encoding the first and second images at a second encoding ratio. Accordingly, it may be possible to provide a viewer with 3D images while minimizing visual fatigue in consideration of a human visual characteristics.

### CROSS-REFERENCE TO RELATED APPLICATION

This application claims priority to Korean Patent Application No. 10-2012-0029534 filed on Mar. 22, 2012, the contents of which are herein incorporated by reference in its entirety.

### TECHNICAL FIELD

The present invention relates to image encoding and decoding and more specifically to a method of controlling a 3D video encoding rate and an apparatus using the same.

### DISCUSSION OF THE RELATED ART

Demand for high-definition broadcast has been increasing since HD digital broadcast has been introduced, and further there is increasing interest in realistic contents that may make users feel like reality. Accordingly, binocular-type contents and binocular-type TV are spreading more and more. In general, a human may feel a 3D effect for an object when the object is viewed by his two eyes that has parallax and the resultant images are combined in his brain. However, general TVs or displays which are 2D-type devices cannot represent captured or taken images in 3D, and thus, users feel as if images displayed by such 2D-type devices are plain (2D) ones. To allow users to have 3D feelings from 2D images, a binocular-type display which is widely used to provide 3D effects have a specialized filter or device installed thereon. Left and right images are output from the display and the left image is viewed only by the user's left eye and the right image only by his right eye. The left and right images are then combined by the user's brain, so that the user happens to feel the combined one as a 3D image. Most of 3D displays are implemented so.

Recently, non-glasses type 3D terminals have appeared which enable users to have realistic feelings in various directions even without special glasses.

However, the conventional binocular-type displays, as described above, require separate specially manufactured glasses for 3D effects, are only appropriate for use in limited spaces or positions, and make user's eyes easy prone to feel exhausted. Non-glasses-type 3D terminals which are advantageous of no need of providing separate glasses, have some limitations, such as 3D contents difficult to generate and requiring a relatively large bandwidth compared to general contents. Further, a user needs to be properly positioned to have 3D effects when viewing the non-glasses type 3D terminal.

### SUMMARY

A first object of the present invention is to provide a 3D video encoding method that adjusts an encoding rate of left and right images to thereby minimize visual fatigue.

A second object of the present invention is to provide a 3D video encoding apparatus that adjusts an encoding rate of left and right images to thereby minimize eye fatigue.

To achieve the first object of the present invention, an image encoding method according to an aspect of the invention may include encoding first and second images at a first encoding ratio, with an encoding rate of the first image different from an encoding rate of the second image and after encoding the first and second images at the first encoding ratio, encoding the first and second images at a second encoding ratio. The second encoding ratio may be an encoding ratio that sets the encoding rate of the first image to the encoding rate of the second image and sets the encoding rate of the second image to the encoding rate of the first image.

The image encoding method may further include setting an encoding ratio of the first and second images, setting a target bit rate for an entire left and right image frame to be encoded, and calculating a target bit rate of the first and second images. The image encoding method may further include determining whether a block to be encoded is a last block in a frame and

when the encoded block is the last block in the frame, determining whether a frame including a current block is a last frame in GOP (Group of Pictures).

To achieve the second object of the present invention, an image encoding apparatus according to an aspect of the present invention may include an encoding ratio setting unit that sets an encoding rate of a first image and an encoding rate of a second image and a plural image encoding unit that performs encoding, with the encoding rate of the first image and the encoding rate of the second image different from each other by the encoding ratio set by the encoding ratio setting unit. The image encoding apparatus may further include a target bit rate setting unit that sets an entire encoding rate of the first and second images. The image encoding apparatus may further include a first determining unit that determines whether an image to be currently encoded is the first image or the second image to perform encoding at a different encoding rate depending on the image and a second determining unit that newly sets an encoding ratio for encoding the first and second images. The first determining unit may determine whether an encoded block is a last encoded block in a frame. The second determining unit may determine whether an encoded frame is a last frame of GOP (Group of Pictures). The image encoding apparatus may further include a target bit rate setting unit that calculates an entire bit rate for transmitting the first and second images.

As described above, the 3D video encoding rate controlling method and the apparatus using the same according to the embodiments of the present invention may perform encoding operations considering a human visual characteristics by switching encoding rates of plural images, and thus may provide 3D images to users while minimizing visual fatigue.

### BRIEF DESCRIPTION OF THE DRAWINGS

FIG. 1 is a flowchart illustrating a 3D video encoding rate controlling method according to an embodiment of the present invention.

FIG. 2 is a conceptual view illustrating a frame structure in an image encoding method according to an embodiment of the present invention.

FIG. 3 is a conceptual view illustrating an image encoding apparatus according to an embodiment of the present invention.

FIG. 4 illustrates the plural image encoding unit 300 according to an embodiment of the present invention.

FIG. 5 is a conceptual view illustrating a portion of an image decoding unit according to an embodiment of the present invention.

FIG. 6 is a conceptual view illustrating an image encoding/decoding method according to an embodiment of the present invention.

### DESCRIPTION OF THE EMBODIMENTS

The present invention may have various modifications and embodiments. Specific embodiments are illustrated in the drawings and the detailed description will be described. However, it is not intended to limit the present invention to the specific embodiments. It should be understood that the invention include all variations and replacements or equivalents thereof should be included in the scope and technical scope of the invention. Similar reference numerals are used to denote similar elements in the drawings. The terms, such as “first” and “second”, may be used to describe various components, but the components should not be limited to the terms. The terms are used only to distinguish one element from another. For example, a first component may be named a second component without departing from the scope of the invention, and similarly, the second component may be also named the first component. The term “and/or” is used to indicate any one or a combination of plural elements.

When an element is “connected to” or “coupled to” another element, the element may be directly connected or coupled to the other element, or an intervening element may be present. On the contrary, when an element is “directly connected to” or “directly coupled to” another element, no intervening element is present.

The terms used herein are used to describe the specific embodiments but not intended to limit the invention. A singular form includes a plural form unless stated otherwise. As used herein, the term “including” or “having” is intended to indicate presence of the features, numerals, steps, operations, elements, parts, or combinations thereof in the specification, not to previously exclude presence or absence of the features, numerals, steps, operations, elements, parts, or combinations thereof.

Hereinafter, embodiments of the present invention are described in detail with reference to the drawings. Hereinafter, the same reference denotations are used to denote the same elements in the drawings, and repetitive description on the same elements are omitted.

The 3D video encoding rate control method according to an embodiment of the present invention may provide further enhanced image quality at the same bit rate while minimizing human visual fatigue in consideration of human visual characteristics for stereoscopic 3D images including the visual characteristic that when images of different quality are respectively viewed by left and right eyes, the images are recognized at the level of the better quality and the visual characteristic that continuous viewing of different quality of images may result in an increase in visual fatigue.

Accordingly, among human visual characteristics for stereoscopic 3D videos, if images of different quality are viewed by left and right eyes, respectively, the images may be recognized at the level of the better quality of image. That is, a human may feel as if left and right images have better quality when the images are encoded at different levels of quality rather than when the images are encoded at the same quality. Accordingly, in the case of binocular 3D videos, assuming that the videos are encoded by two same encoders, encoding is performed with a higher encoding rate assigned to one of the two images and a lower encoding rate to the other, so that a human may view even better quality of 3D videos. That is, to solve the problem that a long-term view of images of different quality through both eyes may increase visual fatigue, the image encoding method according to the present invention assigns different encoding bit rates to left and right images so that the left and right images are encoded at different image quality and regularly switches the left and right images of good and poor quality on the basis of a constant image, such as a GOP (Group of Picture) or a constant time, thereby reducing visual fatigue.

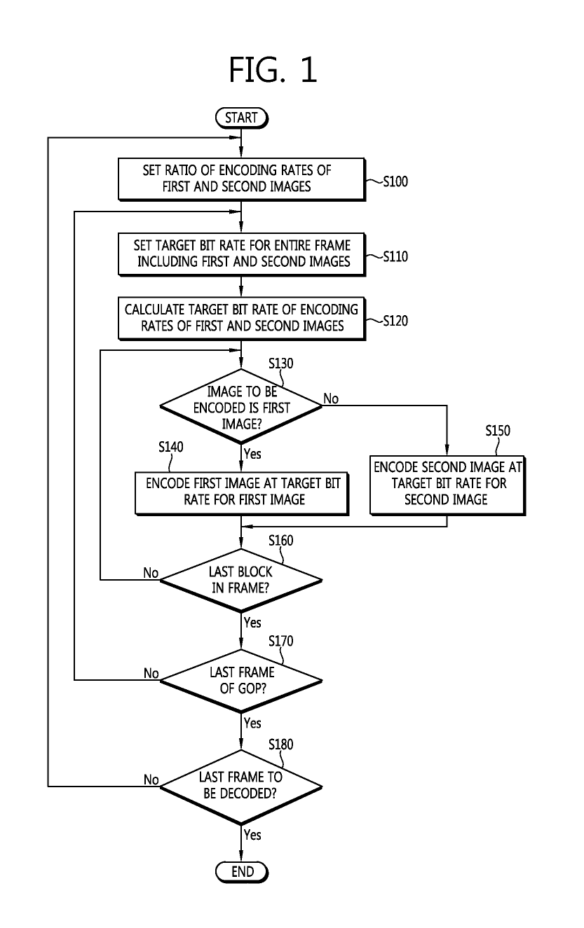

FIG. 1 is a flowchart illustrating a 3D video encoding rate controlling method according to an embodiment of the present invention.

Referring to FIG. 1, a ratio of encoding rates of first and second images are set (step S100).

Hereinafter, in the embodiments of the present invention, to discern a left image or right image, the term “first image” or “second image” may be used.

In consideration of desired image quality difference between the first and second images to be encoded, an encoding ratio of the first and second images may be set. The ratio of the encoding rate of the first image and the encoding rate of the second image may be defined as the term “firs encoding ratio”.

For example, the encoding ratio which is a ratio between the encoding rates of the first and second images may be set as 6:4. The encoding ratio may not be equally set so that one of the first and second images has better image quality than the other.

A target bit rate for the entire frame including the first and second images is set (step S110).

For example, the encoding rate of the first image to be encoded is added to the encoding rate of the second image to be encoded so that the target bit rate for the entire frame may be set as 10 Mbps.

The target bit rates of the first and second images is calculated (step S120).

For example, based on the encoding ratio, 6:4, of the first and second images set in step S100 and the target bit rate, 10 Mbps, for the entire frame including the first and second images, 6 Mbps and 4 Mbps which are respectively target bit rates of the right and left images may be set.

It is determined whether the image to be encoded is the first image or the second image (step S130).

Since the target bit rate varies depending on whether the image to be encoded is the first image or second image, whether the image to be encoded is the first image or second image is determined and depending on a result the images may be encoded at different target bit rates. After the images are discerned, various information relating to encoding of the first and second images, such as information on bit rates at which the first and second images have been encoded and information on which image has been encoded at the higher bit rate, may be encoded as syntax element information.

The first image is encoded at a target bit rate corresponding to the first image (step S140).

The second image is encoded at a target bit rate corresponding to the second image (step S150).

In steps S140 and S150, encoding may be performed on the first and second images at the target bit rates allocated to the first and second images.

It is determined whether the encoded block is the last block in the frame (step S160).

When the currently encoded block is not the last block, the first and second images may be encoded at the existing target encoding rates set in step S130 which determines whether the encoded image is the first image or second image.

Step S160 determines whether the currently encoded image is the first image or the second image, and other methods than that of step S160 may be used to determine whether the currently encoded image is the first image or the second image.

When the encoded block is the last block in the frame, it may be determined whether the frame including the current block is the last frame of GOP (step S170).

According to an embodiment of the present invention, when the frame including the current block is not the last frame of GOP, the procedure returns to step S110 to newly calculate the target bit rate for the entire frame of the left and right images to be encoded.

Step S170 determines whether the currently encoded image is the first image or the second image, and other methods than that of step S170 may be used to determine whether the currently encoded image is the first image or the second image.

When a corresponding frame is the last frame of GOP, it is determined whether the corresponding frame is the last frame of the image to be encoded (step S180).

According to an embodiment of the present invention, when the frame including the current block is the last frame of GOP but is not the last frame to be encoded, the procedure returns to step S100 to adjust the encoding ratio of the left and right images again.

For example, when the first and second images are encoded, the original encoding ratio may apply in an opposite way as if the original encoding rate of the second image is set as the encoding rate of the first image and the original encoding rate of the first image is set as the encoding rate of the second image. The newly set encoding ratio may be defined as the term “second encoding ratio”.

Setting the encoding bit rate ratio of the left and right images at a predetermined cycle or calculating the target bit rate for the entire frame of the left and right images are not limiting methods, and the encoding bit rates of the left and right images or the target bit rate for the entire frame of the left and right images may be obtained at a different cycle.

When it is determined in step S180 that the frame is the last frame of GOP and the last frame to be encoded, the image encoding may be terminated.

In the image encoding method according to the embodiments of the present invention, when different image qualities of images are viewed by the left and right eyes, the images are viewed as good as the image having the better quality. To address an increase in visual fatigue that happens upon long-time watching, different image encoding ratios are set to a constant image unit, such as GOP, thereby resulting in a decrease in such fatigue. GOP is merely an example of the constant image encoding unit, and other units than GOP may be also used, which are also within the scope of the invention.

As described above, information used to encode the first and second images at different encoding rates, such as encoding rate information of the first image bit stream, encoding rate information of the second image bit stream, or information on whether the current frame is the last frame of GOP, may be encoded as syntax elements. Hereinafter, in an embodiment of the present invention, the information used to encode the first and second images at different encoding rates, such as encoding rate information of the first image bit stream, encoding rate information of the second image bit stream, or information on whether the current frame is the last frame of GOP may be defined as “per-cycle asymmetric encoding syntax element information”.

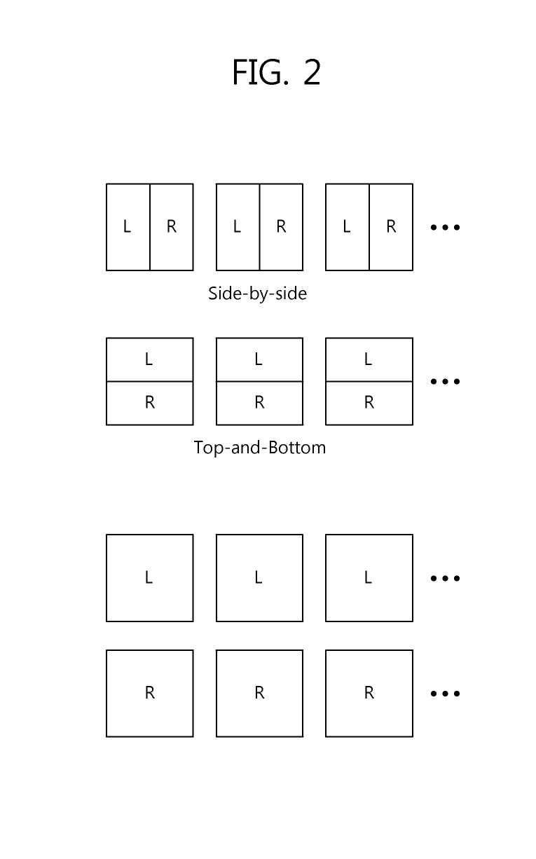

FIG. 2 is a conceptual view illustrating a frame structure in an image encoding method according to an embodiment of the present invention.

Referring to FIG. 2, a binocular-type 3D video frame may be implemented as having a frame compatible format as illustrated in an upper portion of FIG. 2 or a service compatible format as illustrated in a lower portion of FIG. 2. In a frame encoding method of left and right images according to an embodiment of the present invention, in the case that different encoding rates are set to the left and right images, when the corresponding image information is decoded in a 2D frame, the service compatible frame may be decoded by periodically switching the one having higher encoding rate of the left and right images. Accordingly, such periodical switching to the image having higher quality is performed so that 3D video of better quality may be provided at the same encoding rate in the 3D video service without affecting the 2D video service.

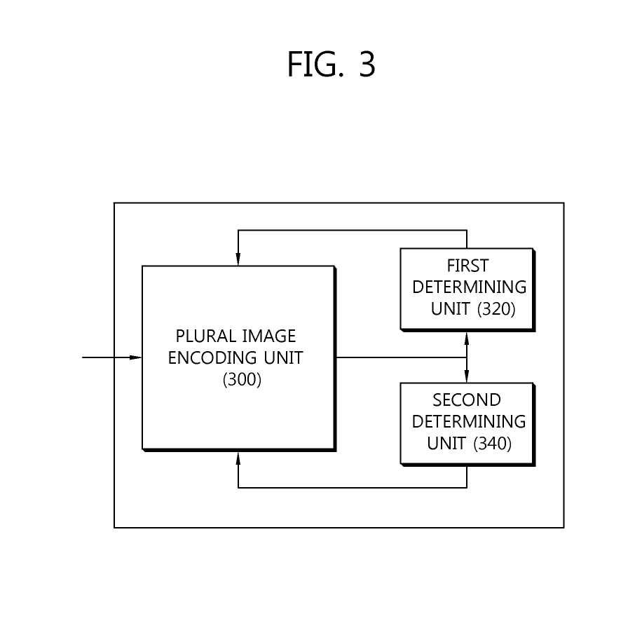

FIG. 3 is a conceptual view illustrating an image encoding apparatus according to an embodiment of the present invention.

Referring to FIG. 3, the encoding apparatus may include a plural image encoding unit 300, a first determining unit 320, and a second determining unit 340.

For ease of description, each component is separately provided, but at least two of the components may be combined into a single component or a single component may be divided into plural components. Such combination or division of the components is also within the scope of the invention as long as it does not depart from the gist of the invention.

Further, some components are not necessary to perform essential functions of the invention but rather may be optional components provided to enhance performance. The invention may be implemented as components inevitable to implement the gist of the invention without components used for purposes of enhancing performance, and such design or structure is also within the scope of the invention.

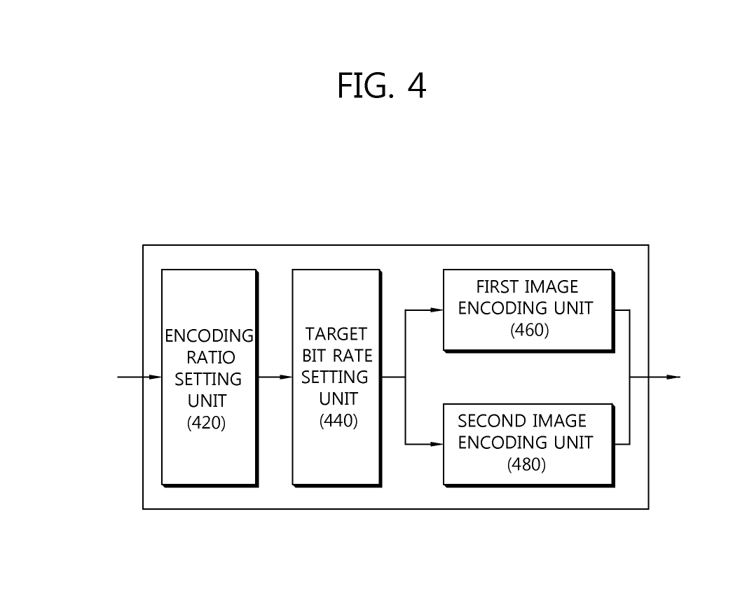

FIG. 4 illustrates the plural image encoding unit 300 according to an embodiment of the present invention.

The plural image encoding unit 300 may include an encoding ratio setting unit 420, a target bit rate setting unit 440, a first image encoding unit 460, and a second image encoding unit 480.

The encoding ratio setting unit 420 may determine a ratio of the encoding rates of the first and second images. For example, the encoding ratio setting unit 420 may set an encoding ratio of the first and second images as a predetermined ratio, such as 6:4. The encoding rate of the first image and the encoding rate of the second image may be defined as the term “first encoding ratio”. As described above, in the image encoding method according to an embodiment of the present invention, if images of different image qualities are viewed by the left and right eyes, human visual characteristics enable the images to be viewed at the level of the better quality of image. The encoding ratio setting unit 420 may be used to set different image encoding ratios to a constant image unit, such as GOP, so as to address the problem that long hours of watching increases visual fatigue. That is, the encoding ratio setting unit 420 may set the encoding ratio of the first and second images differently at a constant image unit cycle.

The target bit rate setting unit 440 may set a bit ratio of an entire image to transmit information of the first and second images.

The first image encoding unit 460 and the second image encoding unit 480 may perform encoding according to the target encoding rates of the first and second images set by the encoding ratio setting unit 420 and the target bit rate setting unit 440. In the image encoding method according to an embodiment of the present invention, the encoding rates of the first and second images may be set to be different from each other. The first image encoding unit 460 and the second image encoding unit 480 are separately represented for convenience of description but may be also implemented as a single encoding unit.

The first determining unit 320 determines whether the currently encoded image is the first image or the second image to perform encoding at different encoding rates depending on the image. For example, the first determining unit 320 may determine whether the currently encoded block is the block encoded last in the frame, and when the currently encoded block is the last encoded block, determine whether an image to be encoded next is the first image or the second image so that the first image encoding unit 460 or the second image encoding unit 480 may perform encoding.

The second determining unit 340 may newly set the encoding ratio for encoding the first and second images.

For example, the second determining unit 340 may determine whether the encoded frame is the last frame among frames to be encoded. When the second determining unit 340 determines that the currently encoded frame is the last frame, the encoding ratio setting unit 320 may set the encoding ratio of the first and second images again.

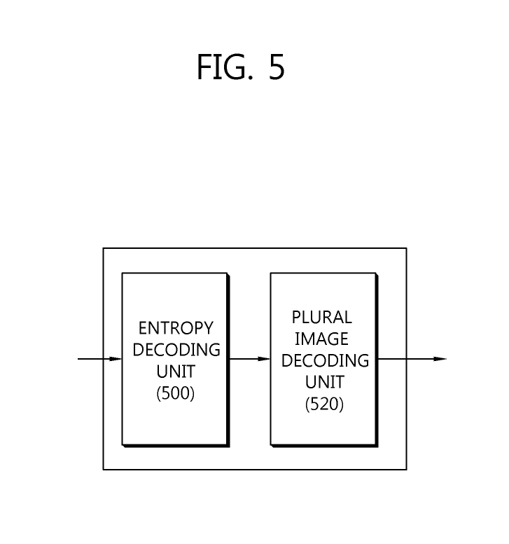

FIG. 5 is a conceptual view illustrating a portion of an image decoding unit according to an embodiment of the present invention.

Referring to FIG. 5, the image decoding unit may include an entropy decoding unit 500 and a plural image decoding unit 520.

The entropy decoding unit 500 may decode the above-described per-cycle asymmetric encoding syntax element information to thereby decode the information on a ratio in which the first and second images are encoded and to thereby decode encoding-relating information, such as information on a cycle at which the corresponding encoding ration is switched. According to an embodiment of the present invention, the entropy decoding unit 500 may decode basic image encoding parameter information only without encoding additional per-cycle asymmetric encoding syntax element information, so that decoding is performed with the decoding ratio of the first and second images periodically changing.

The plural image decoding unit 520 may decode the first and second images based on the image information decoded in the entropy decoding unit 500. The first and second images may be decoded based on the encoding ratio of the first and second images that have been encoded in the encoding step. That is, the first and second images may be decoded at a first decoding ration which is the same as the first encoding ratio at which the first and second images have been encoded.

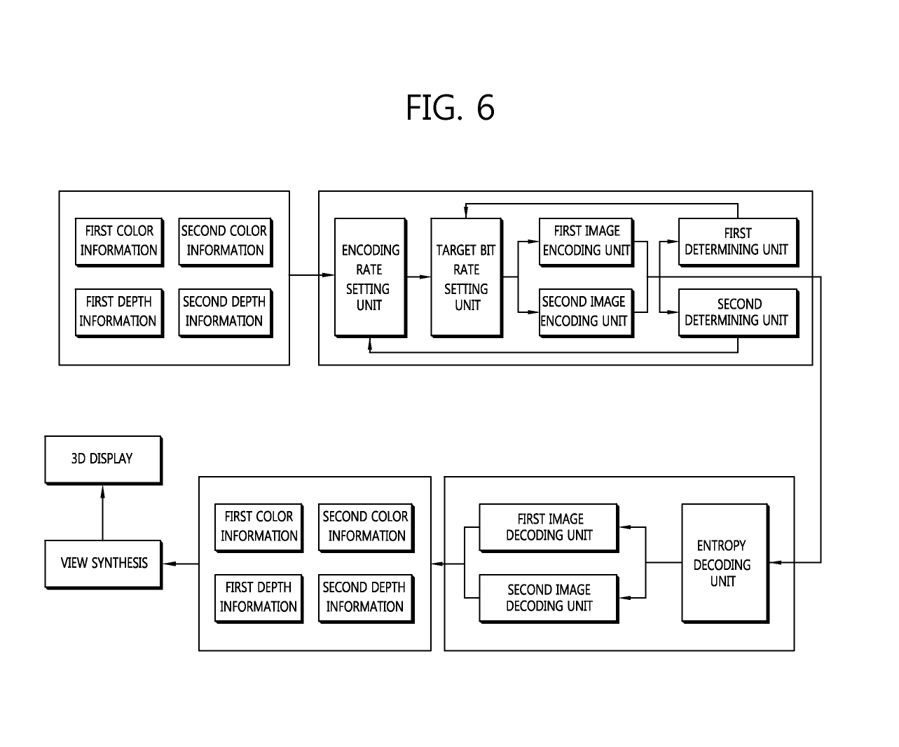

FIG. 6 is a conceptual view illustrating an image encoding/decoding method according to an embodiment of the present invention.

Hereinafter, for convenience of description, FIG. 6 illustrates a method of separately encoding/decoding depth information and color information in a frame compatible manner. However, a different encoding rate of the bit stream may apply to various frame formats, such as an example where depth information is separately generated and produced from frame information without being encoded or an example where depth information is separately encoded and decoded, such as an advanced 3D scheme.

Referring to FIG. 6, the left image may include first color information and first depth information, and the right image may include second color information and second depth information.

Each image information may be encoded by an encoder, and as described above, encoding may be performed with different encoding rates applying to the left and right images.

Various components, such as the encoding ratio setting unit, the target bit rate setting unit, the first image encoding unit, the second image encoding unit, the first determining unit, and the second determining unit shown in FIG. 4, independently or in combination, may constitute an encoding unit. The encoding ratio setting unit may set a ratio of encoding rates of the left and right images, and the target bit rate setting unit may set a target bit rate based on an available encoding rate. The left image encoding unit and the right image encoding unit may perform encoding according to the target encoding rates of the left and right images set by the encoding ratio setting unit and the target bit rate setting unit.

A block determining unit and a frame determining unit may determine whether the currently encoded block is the last encoded block in the current frame, and the frame determining unit may determine whether the currently encoded frame is the last frame of GOP.

Information generated by each component, for example, information used for encoding the left and right images at different encoding rates, such as encoding rate information of the current left image bit stream or encoding rate information of the right image bit stream, and information on whether the current frame is the last frame of GOP, may be encoded as syntax elements. Hereinafter, in an embodiment of the present invention, the information used for encoding the left and right images at different encoding rates, such as encoding rate information of the current left image bit stream or encoding rate information of the right image bit stream, and information on whether the current frame is the last frame of GOP, may be defined as “per-cycle asymmetric encoding syntax element information”.

Or, the encoding unit may perform encoding on the left and right images based on different encoding rates by adjusting parameter information used for image encoding without separately generating syntax element information for asymmetric encoding, so that separate information is not transmitted to the decoding unit. Further, the above-described components, which are merely an example, may be split or combined with each other. The image information encoded by the above-described method may be sent to the decoding unit.

The decoding unit may perform decoding at different decoding rates based on the asymmetric encoding syntax element information or may periodically perform asymmetric decoding based on basic image parameter information without additionally receiving the asymmetric encoding syntax element information. The image information decoded at the asymmetric decoding rates is subjected to view synthesis using the depth information and the image information and may be then displayed on the 3D display.

Although the embodiments of the present invention have been described, it will be understood by those skilled in the art that various modifications may be made to the present invention without departing from the spirit and scope of the appended claims.

What is claimed is:

1. An image encoding method comprising:
encoding first and second images at a first encoding ratio, with an encoding rate of the first image different from an encoding rate of the second image; and
after encoding the first and second images at the first encoding ratio, encoding the first and second images at a second encoding ratio.

2. The image encoding method of claim 1, wherein the second encoding ratio is an encoding ratio that sets the encoding rate of the first image to the encoding rate of the second image and sets the encoding rate of the second image to the encoding rate of the first image.

3. The image encoding method of claim 1, further comprising:
setting an encoding ratio of the first and second images;
setting a target bit rate for an entire left and right image frame to be encoded; and
calculating a target bit rate of the first and second images.

4. The image encoding method of claim 1, further comprising:
determining whether a block to be encoded is a last block in a frame; and
when the encoded block is the last block in the frame, determining whether a frame including a current block is a last frame to perform encoding.

5. An image decoding method comprising:
decoding encoding rate information of a first image and encoding rate information of a second image; and
decoding the first and second images based on the decoded encoding rate information of the first image and the decoded encoding rate information of the second image.

6. The image decoding method of claim 5, further comprising decoding information on a cycle at which encoding rates of the first and second images switch.

7. An image encoding apparatus comprising:
an encoding ratio setting unit that sets an encoding rate of a first image and an encoding rate of a second image; and
a plural image encoding unit that performs encoding, with the encoding rate of the first image and the encoding rate of the second image different from each other by the encoding ratio set by the encoding ratio setting unit.

8. The image encoding apparatus of claim 7, further comprising a target bit rate setting unit that sets an entire encoding rate of the first and second images.

9. The image encoding apparatus of claim 7, further comprising:
a first determining unit that determines whether an image to be currently encoded is the first image or the second image to perform encoding at a different encoding rate depending on the image; and
a second determining unit that newly sets an encoding ratio for encoding the first and second images.

10. The image encoding apparatus of claim 9, wherein the first determining unit determines whether an encoded block is a last encoded block in a frame.

11. The image encoding apparatus of claim 9, wherein the second determining unit determines whether an encoded frame is a last frame of frames to be encoded.

12. The image encoding apparatus of claim 7, further comprising a target bit rate setting unit that calculates an entire bit rate for transmitting the first and second images.

13. An image decoding apparatus comprising:
an entropy decoding unit that decodes information on an encoding rate at which a first image is encoded and information on an encoding rate at which a second image is encoded; and
a plural image decoding unit that performs decoding based on encoding information of the first image decoded by the entropy decoding unit and encoding information of the second image decoded by the entropy decoding unit.

14. The image decoding apparatus of claim 13, wherein the entropy decoding unit includes an entropy decoding unit that decodes information on a ratio at which the encoding rates of the first and second images switch.
